(19) United States
(12) Patent Application Publication
(10) Pub. No.: US 2019/0032890 A1
(43) Pub. Date: Jan. 31, 2019

(54) LIGHTING SYSTEM

(71) Applicant: PANASONIC INTELLECTUAL PROPERTY MANAGEMENT CO., LTD., Osaka (JP)

(72) Inventor: Yoshiyuki NAKANO, Osaka (JP)

(73) Assignee: PANASONIC INTELLECTUAL PROPERTY MANAGEMENT CO., LTD., Osaka (JP)

(21) Appl. No.: 16/045,122

(22) Filed: Jul. 25, 2018

(30) Foreign Application Priority Data
Jul. 28, 2017 (JP) 2017-146069

(51) Int. Cl. F21V 9/35; F21V 8/00; E01F 9/20; B64F 1/20

(52) U.S. Cl. CPC F21V 9/35; G02B 6/0006; F21W 2111/02; E01F 9/20; B64F 1/20; G02B 6/001

(57) ABSTRACT

A lighting system is provided. The lighting system includes a light source. A wavelength converter is configured to convert a wavelength of light emitted from the light source. A light guide tube is configured to propagate and transmit incoherent light emitted from the wavelength converter. The light guide tube extends along a road.

### CROSS REFERENCE TO RELATED APPLICATION

The entire disclosure of Japanese Patent Application No. 2017-146069 filed on Jul. 28, 2017 including the specification, claims, drawings, and abstract is incorporated herein by reference in its entirety.

### TECHNICAL FIELD

The present disclosure relates to relates to a lighting system.

### BACKGROUND

On a road where cars travel, a runway at an airport where airplanes take off and land, and the like, there are installed lighting apparatuses for showing a position of a predetermined path on which the mobile bodies should travel and guiding the mobile body to an appropriate place. For example, Japanese Patent No. 5291101 B discloses a lighting system provided with laser light sources emitting laser light and tapered fibers propagating the laser light, the tapered fibers being arranged on a road surface where mobile bodies come and go and extended in a guide direction.

### SUMMARY

According to the lighting system disclosed in Japanese Patent No. 5291101 B, mobile bodies such as cars and airplanes can be guided to predetermined paths on which they should travel. In the lighting system, however, since light propagating the tapered fiber is laser light, it is necessary to use, for example, thick fibers or to weaken output of the laser light in consideration of eye safety. In this case, problems are assumed such as that the system is large-scaled and that light emitted from the fibers is weakened, which deteriorates visibility.

A lighting system that is an aspect of the present disclosure is provided with: a light source; a wavelength converter configured to convert a wavelength of light emitted from the light source; and a light guide tube configured to propagate and transmit incoherent light emitted from the wavelength converter. The light guide tube extends along a path.

According to a lighting system that is an aspect of the present disclosure, a predetermined path on which a mobile body such as a car or an airplane, or a person should travel can be shown by incoherent light propagating through a light guide tube, and, for example, the mobile body can be guided to a suitable place. Further, the light guide tube can be caused to shine brightly to secure good visibility, and it is also possible to aim at downsizing of the system.

### BRIEF DESCRIPTION OF DRAWINGS

The drawings show one or more embodiments according to the present disclosure not as restrictions but as mere examples. In the drawings, similar reference numerals indicate the same or similar elements.

FIG. 1 is a diagram showing a lighting system that is an example of an embodiment, in which light guide tubes are arranged extending along a road;

FIG. 2 is a diagram showing an overall configuration of the lighting system that is an example of the embodiment;

FIG. 3 is a diagram showing a modification of the lighting system that is an example of the embodiment;

FIG. 4 is a sectional view of a light guide tube that is an example of the embodiment;

FIG. 5 is a sectional view of a light guide tube that is another example of the embodiment;

FIG. 6 is a diagram showing the lighting system installed on a runway at an airport;

FIG. 7 is a diagram showing the lighting system installed on wall surfaces of a path;

FIG. 8 is a diagram showing the lighting system installed on a road extending along a river; and

FIGS. 9A and 9B are diagrams showing states in which the light guide tube floating on a water surface in a lighting system that is another example of the embodiment.

### DESCRIPTION OF EMBODIMENTS

An example of an embodiment of a lighting system of the present disclosure will be described in detail below with reference to drawings. From the beginning, it is assumed that components of the embodiment and a plurality of modifications described below are selectively combined. Further, since drawings referred to in the description of the embodiment are schematically drawn, a dimension ratio and the like of components shown in the drawings should be determined in consideration of the description below.

Though a road 100, a runway 110, a path 120 and a levee road 132 are shown as paths provided with light guide tubes, locations where light guide tubes are installed are not limited thereto. For example, the light guide tubes may be installed on a dedicated bicycle road, a sidewalk, a crosswalk, a platform in a station, a parking lot, a bicycle parking lot, corridors in various facilities and the like. Further, the light guide tubes may be provided in the air in order to cause an unmanned aircraft such as a drone to fly along a predetermined path. The unmanned aircraft may fly along the light guide tubes by detecting light of the light guide tubes. In this case, it can be said that a path is formed by the light guide tubes.

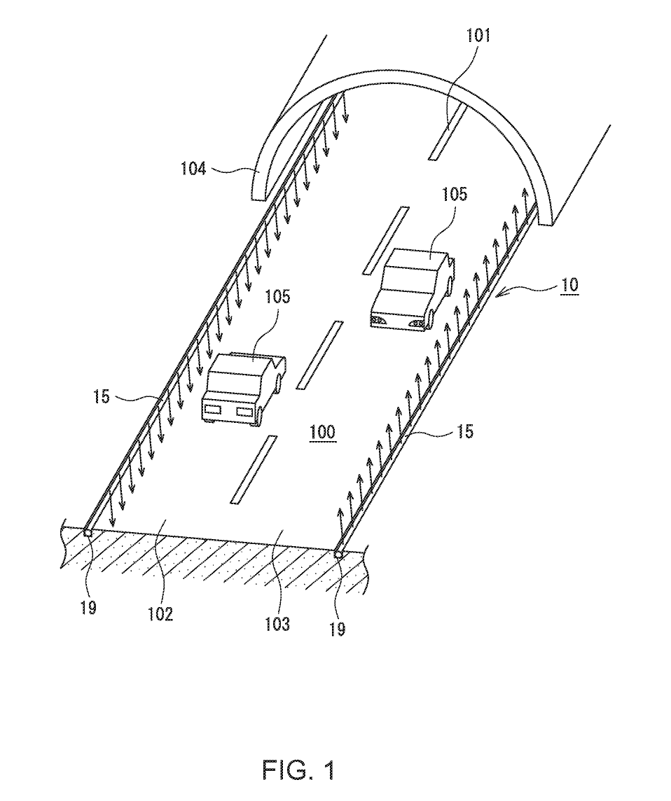

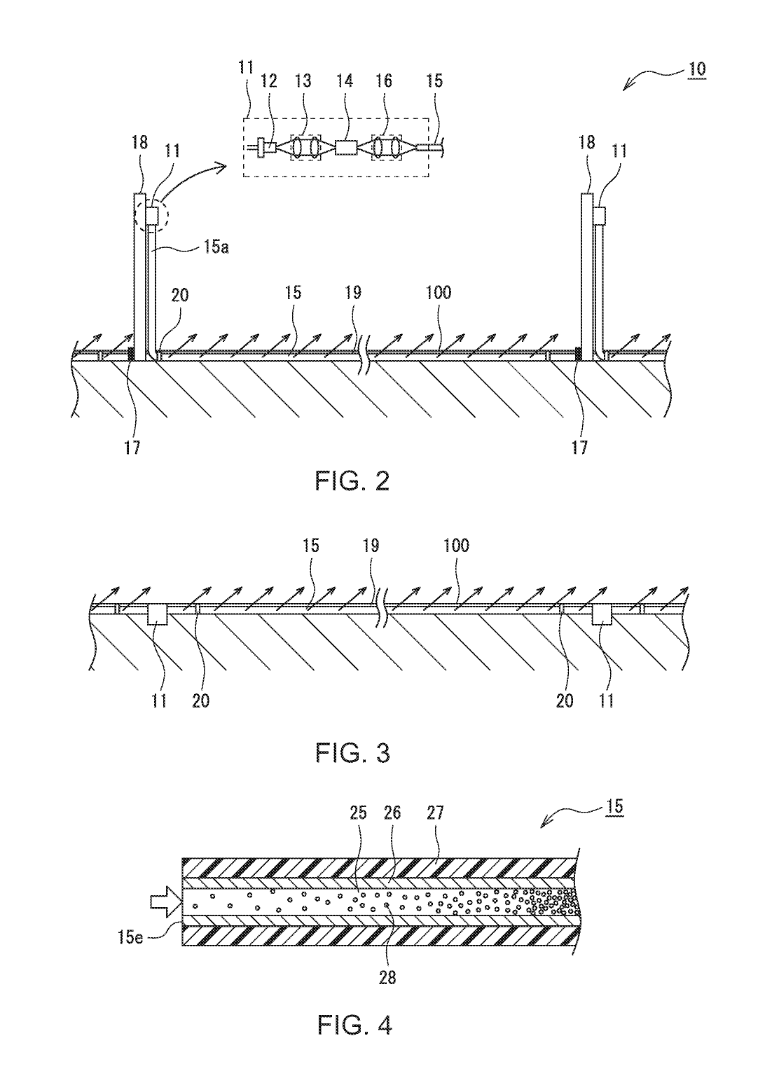

FIGS. 1 and 2 are diagrams showing a lighting system 10 that is an example of the embodiment. As exemplified in FIGS. 1 and 2, the lighting system 10 is provided with light sources 12, wavelength converters 14 that perform wavelength conversion of light emitted from the light sources 12, and light guide tubes 15 that configured to propagate and transmit incoherent light emitted from the wavelength converters 14. Light sources 12 are solid light sources. In the example shown in FIG. 1, the light guide tubes 15 are arranged extending along a road 100. Further, the light guide tubes 15 are also installed in a tunnel 104. The light guide tubes 15 cause incoherent light introduced from end faces to propagate in a length direction while emitting a part of the incoherent light.

The lighting system 10 is provided with light source devices 11 each of which includes the solid light source 12 and the wavelength converter 14. Each of the light source devices 11 further includes optical members 13 and 16. The optical member 13 is arranged between the solid light source 12 and the wavelength converter 14, and is configured, for example, with a collimator lens that causes light emitted from the solid light source 12 to be parallel light and a condensing lens that condenses the parallel light and introduces the parallel light into the wavelength converter 14. The optical member 16 is arranged between the wavelength converter 14 and an end face of the light guide tube 15 and may be configured with a collimator lens and a condensing lens similar to the optical member 13.

The lighting system 10 is configured so that light emitted from the solid light source 12 is introduced into the light guide tube 15 from the end face of the light guide tube 15 via the wavelength converter 14, and the light guide tube 15 shines over the entire length, or only a particular range. The lighting system 10 includes illuminance sensors (not shown) that detect ambient brightness, and the light sources 12 light up when it becomes dark around the solid light source 12, based on detection information of the sensors. The light sources 12, however, may be continuously lit up. The lighting status of the light sources 12 is not especially limited. The light sources 12 may be blinking.

The lighting system 10 is provided with control devices (not shown) that control operation of the light sources 12, such as lighting up and extinction. For example, the control devices may be included in the light source devices 11, respectively, or may be provided at a rate of one for a plurality of light source devices 11. Otherwise, the control devices may be provided at a place away from the light source devices 11 such as a management facility of the road 100 so that control signals are transmitted to the light source devices 11 from the control devices. Further, in the case where sensors such as the illuminance sensors are provided, the sensors may be provided in the light source devices 11, respectively, or may be provided at a rate of one for a plurality of the light source devices 11.

In the example shown in FIG. 1, the light guide tubes 15 are provided on both width-direction end portions of the road 100 along the road 100. The light guide tubes 15 are provided on a road surface of the road 100. Though the light guide tubes 15 may be arranged on the road surface, they are preferably accommodated in grooves 19 formed in the road surface. The grooves 19 are recess portions formed in the road surface and formed along the road 100. It is preferable that the light guide tubes 15 be accommodated in the grooves 19 in a state of not projecting above the road surface, and that the grooves 19 be formed with a depth equal to or larger than the diameter of the light guide tubes 15.

However, it is preferable that the light guide tubes 15 be accommodated in the grooves 19 within such a range that the light guide tubes 15 can be directly seen by drivers or the like of cars 105 traveling on the road 100. By providing the grooves 19 to accommodate the light guide tubes 15, the light guide tubes 15 do not obstruct traffic and the like, and breakage and the like of the light guide tubes 15 are unlikely to occur. The light guide tubes 15 are fixed in the grooves 19 with fixing members 20. The fixing members 20 are, for example, U-shaped metal fittings and press the light guide tubes 15 from above.

The road 100 is a road with one lane on each side, and, at the center of the road 100, a center line 101 separating lanes 102 and 103 is provided. In FIG. 1, the lane 102 is a lane on which cars 105 travel in a direction toward the tunnel 104 from this side, and the lane 103 is a lane on which cars 105 travel in a direction from the tunnel 104 toward this side. The light guide tubes 15 and the grooves 19 are provided on end portions on opposite sides of the center line 101 among end portions of the lanes 102 and 103.

The light guide tubes 15 and the grooves 19 may be provided on or near the center line 101. Further, in the tunnel 104, the light guide tubes 15 may be provided on wall surfaces of the tunnel 104.

It is preferable that incoherent light introduced into the light guide tubes 15 propagate in a direction opposite to a traveling direction of the cars 105 traveling on each of the lanes 102 and 103. That is, through the light guide tube 15 arranged on the end portion of the lane 102, light propagates in the direction from the tunnel 104 toward this side, and, through the light guide tube 15 arranged on the end portion of the lane 103, light propagates in the direction toward the tunnel 104 from this side. In this case, the incoherent light emitted from each of the light guide tubes 15 is radiated from the front of the cars 105, and visibility of the light guide tubes 15 is improved. Slits (slit-shaped recesses) or the like for causing the incoherent light to be transmitted may be formed in the light guide tubes 15. For example, by adjusting an angle of the slits, light can be radiated from the front of the cars 105.

As the light sources 12, light emitting diodes (LEDs), organic EL (OEL) elements, semiconductor lasers and the like can be exemplified. In the lighting system 10, light introduced into the light guide tubes 15 is only required to be incoherent light. The incoherent light may be emitted from the light sources 12. Preferably, however, coherent light of the light sources 12 is converted to incoherent light by the wavelength converters 14. The light sources 12 are semiconductor lasers, and semiconductor lasers that output near-ultraviolet light or blue light are especially preferred.

The wavelength converters 14 convert, for example, a wavelength of coherent light emitted from semiconductor lasers and introduced via the optical members 13 and emit incoherent light. As the wavelength converters 14, conventionally well-known phosphors can be used. It is preferable that the wavelength converters 14 convert near-ultraviolet light or blue light of the semiconductor lasers to white light. The incoherent light emitted from the wavelength converters 14 is introduced into the light guide tubes 15 from the end faces of the light guide tubes 15 via the optical members 16.

In the lighting system 10, by introducing the incoherent light converted by the wavelength converters 14 into the light guide tubes 15, safety measures required in the case of using coherent light become unnecessary. Therefore, for example, it is possible to increase output of light to cause the light guide tubes 15 to shine brighter, and it becomes possible to improve visibility of the tubes. Further, it is possible to thin the light guide tubes 15 in order to downsize the system, reduction in material costs and the like.

The wavelength converters 14 convert the wavelength of the light of the light sources 12 to at least one of a visible wavelength and an infrared wavelength. For example, the wavelength converters 14 convert the light of the light sources 12 only to incoherent light with a visible wavelength. On the other hand, the wavelength converters 14 may convert the light of the light sources 12 to incoherent light with an infrared wavelength corresponding to a detection wavelength of a camera of an automatic driving system, a driving support system or the like. Further, the light of the light sources 12 may be converted to incoherent light with a visible wavelength or incoherent light with an infrared wavelength.

In the example shown in FIG. 2, one solid light source 12 and one wavelength converter 14 are provided for one light guide tube 15, and incoherent light is introduced from one end face of the light guide tube 15. On the other end face side of the light guide tubes 15, a light-shielding member 17 is provided. One light source device 11 may be installed on each of both length-direction end portions of the light guide tubes 15 so that incoherent light may be introduced from both end faces of the light guide tube 15.

In order that strong light emitted from the other end face of the light guide tube 15 does not enter persons' eyes, the light-shielding member 17 absorbs the light emitted from the end face. The light-shielding member 17 is provided, for example, in the groove 19 in a state of being in contact with the other end face of the light guide tube 15. The light-shielding member 17 may be attached to a support column 18 to be described later, and a side face of the support column 18 may be used as the light-shielding members 17. A reflecting member that reflects light emitted from the other end face of the light guide tube 15 may be provided instead of the light-shielding member 17. By providing the reflecting member, incoherent light can be returned to the light source device 11 side, and it is possible to increase light use efficiency.

The lighting system 10 is provided with a plurality of support columns 18 installed at intervals in the length direction of the light guide tubes 15, and the light source devices 11 each of which includes the solid light source 12 and the wavelength converter 14 may be fixed to the support columns 18. In this case, it is possible to prevent the light source devices 11 from becoming immersed in water when the road 100 is submerged, and it is possible to simplify waterproof measures for the light source devices 11. One light guide tube 15 has a length corresponding to a distance between two support columns 18.

The support columns 18 may be equipment dedicated to the lighting system 10 or may also be used as utility poles and the like. For example, existing utility poles may be used as the support columns 18. Though an interval between the support columns 18 and the length of one light guide tube 15 are not especially limited, they are preferably 10 to 150 m. Each of the support columns 18 has, for example, a length of 1 m or more and is provided standing almost perpendicular to the road surface of the road 100. In the example shown in FIG. 2, one light source device 11 is installed on an upper part of one support column 18.

In the case where the light source device 11 is attached to the upper part of the support column 18, one length-direction end portion 15a of the light guide tubes 15 extends in a vertical direction along the support column 18. The remaining part of the light guide tube 15 except the one end portion 15a extends along the road 100. The light guide tube 15 may be configured to transmit light over the entire length and shine over the entire length or may be configured such that a part excluding the one end portion 15a shines. In the latter case, a light-shielding film may be provided over the one end portion 15a so that light is not transmitted from the one end portion 15a.

In an example shown in FIG. 3, the light source devices 11 are embedded in the road 100. In this case, stricter waterproof measures are required for the light source devices 11 compared with the case of attaching the devices to the support columns 18. Though the light source devices 11 may be arranged on the road surface, they are preferably embedded in the road surface in a state of not projecting higher than the road surface. In the example shown in FIG. 3, two light guide tubes 15 are connected to one light source device 11. The light source device 11 may be configured such that incoherent light is introduced from end faces of the two light guide tubes 15 or may include a light shielding member or a reflecting member that is in contact with the end face of one light guide tube 15.

As exemplified in FIG. 4, each light guide tube 15 includes a core 25 and a cladding material 26. Incoherent light emitted from the wavelength converter 14 is introduced into the core 25 and propagated in the length direction through the core 25 while reflecting by an interface between the core 25 and the cladding material 26. The light guide tube 15 is, however, configured to cause a part of the incoherent light introduced from an end face to be transmitted. The light guide tube 15 causes the incoherent light to propagate in the length direction while causing a part of the incoherent light to be released to the outside.

It is preferable that the light guide tube 15 include a light diffusing material 28. A part of the incoherent light propagating through the core 25 is not reflected by the interface between the core 25 and the cladding material 26 but is released to the outside. However, by using the light diffusing material 28, it becomes easy to adjust an amount of release of light. Light that includes hit the light diffusing material 28 and been diffused is easy to be transmitted through the cladding material 26 and released to the outside. The light diffusing material 28 is included in at least one of the core 25 and the cladding material 26. Though the light diffusing material 28 dispersedly exists only in the core 25 in the example shown in FIG. 4, the light diffusing material 28 may exist only in the cladding material 26 or may exist in both of the core 25 and the cladding material 26.

It is preferable that optical diffusibility of the light guide tube 15 be higher at a part further from an incoherent light incident end face 15e than a part close to the incoherent light incident end face 15e. In this case, it becomes easy to cause the whole light guide tube 15 to shine with uniform brightness. In the example shown in FIG. 4, a content of the light diffusing material 28 gradually increases as a distance from the incident end face 15e increases. In the case of causing the one end portion 15a not to shine, the one end portion 15a is generally not made to include the light diffusing material 28. In this case, it is preferable to, in the part except the one end portion 15a, cause the content of the light diffusing material 28 to gradually increase as the distance from the incident end face 15e increases.

In the case where incoherent light is introduced from only one end face of the light guide tube 15 (see FIG. 2), the content of the light diffusing material 28 may be highest near the other end face (an end face on a side opposite to the incident end face 15e). In the case where incoherent light is introduced from both end faces of the light guide tube 15, the content of the light diffusing material 28 becomes highest, for example, at a center in the length direction. The optical diffusibility of the light guide tube 15 can be varied by adding light diffusing material with a low optical diffusibility to a part located on the incident end face 15e side and adding light diffusing material with a high optical diffusibility to a part further from the incident end face 15e.

The light diffusing material 28 may be anything that is dispersible in the light guide tube 15 and can diffuse incoherent light. A preferable example of the light diffusing material 28 is resin particles with a particle diameter of several μm, and acrylic resin particles, polystyrene particles, silicone resin particles and the like can be given. Inorganic compound particles such as silica and titania particles can be used as the light diffusing material 28. The tapered fiber disclosed in JP 5291101 B may be applied to the light guide tube 15.

It is preferable that an outer circumferential face (a surface) of the cladding material 26 of the light guide tube 15 be coated with resin. The light guide tube 15 exemplified in FIG. 4 includes a resin film 27 formed on the surface of the cladding material 26. The resin film 27 has a function of protecting the light guide tube 15 to improve durability and weather resistance and is made of transparent resin that causes incoherent light introduced into the light guide tube 15 to be transmitted, or diffused and transmitted. In particular, it is preferable that the resin film 27 be formed with fluororesin. The light diffusing material 28 may be included in the resin film 27.

The light guide tube 15 may have an uneven shape at least on the outer circumferential face of the cladding material 26 instead of the light diffusing material 28 or in addition to the light diffusing material 28. Here, the uneven shape is a slightly uneven shape. The uneven shape has a function of diffusing incoherent light introduced into the light guide tube 15 similarly to the light diffusing material 28. Surfaces of a core and a cladding material of a general light guide tube are formed smooth. In the light guide tubes 15, however, optical diffusibility is given to adjust an amount of transmission of light, for example, by forming the uneven shape on the surface of the cladding material 26.

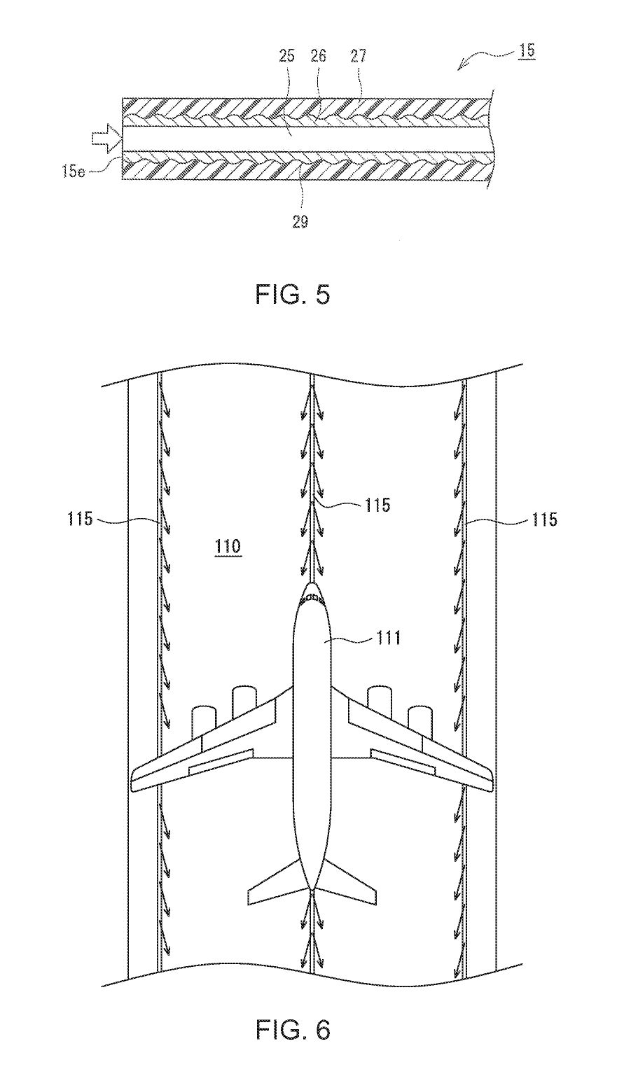

In an example shown in FIG. 5, unevenness 29 is formed on the outer circumferential face of the cladding material 26 along the length direction of the light guide tube 15. The unevenness 29 may be formed on a part of the cladding material 26 in a circumferential direction or may be formed over the entire length in the circumferential direction. Further, the unevenness 29 may be regularly formed or may be formed by irregularly roughening the surface of the cladding material 26. The shape of the unevenness 29 is not especially limited. As an example, the unevenness 29 in a gentle waveform as shown in FIG. 5 is given. The unevenness 29 may be formed by V-shaped or thin line-shaped slit recess portions cut in the light guide tube 15.

The uneven shape like the above unevenness 29 may be formed only on the cladding material 26 or may be formed beyond the interface between the cladding material 26 and the core 25 from the surface of the cladding material 26. That is, recess portions with a depth reaching the core 25 may be formed in the light guide tubes 15. For example, when the light guide tube 15 is long, unevenness with shallow recess portions may be formed only on the cladding material 26 as means for causing the whole light guide tube 15 to shine. On the other hand, when the light guide tubes 15 are short, recess portions deeper than the interface between the cladding material 26 and the core 25 can be formed to increase the amount of transmission of light.

When the uneven shape as described above is formed on the light guide tubes 15 also, it is preferable that the optical diffusibility be higher at the part further from the incoherent light incident end face 15e than the part close to the incoherent light incident end face 15e similarly to the case of using the light diffusing material 28. For example, the depth of the recess portions of the uneven shape may be formed to be gradually deeper, or density of formation of recess portions of the uneven shape may be gradually higher as the distance from the incident end face 15e increases. The depth of the recess portions, for example, increase as a distance from the end face increases. A specific example is to increase a ratio of a length of the recess portion in a direction perpendicular to a light traveling direction (a radial direction of the tube) to a length of the recess portion in the light traveling direction (the length direction of the tube) as the distance from the incident end face 15e increases. By changing the uneven shape along the length direction of the light guide tube 15, the optical diffusibility, that is, light transparency of the light guide tube 15 can be adjusted.

According to the lighting system 10 provided with above configuration, positions of ends of the road 100 can be shown by the light guide tubes 15 arranged extending along the ends of the road 100. Therefore, at night and when visibility is bad due to rainfall, snowfall, dense fog or the like, or in a dark place like an inside of the tunnel 104, the positions of the ends of the road 100 can be easily recognized by the drivers of the cars 105 or cameras of automatic driving systems, driving assistant systems and the like. The light guide tubes 15 may be provided along the center line 101 as described above. The cars 105 are guided to appropriate lanes on which they should travel, by the light guide tubes 15.

In the lighting system 10, since light propagating the light guide tubes 15 is incoherent light converted by the wavelength converters 14, safety measures required in the case of using coherent light become unnecessary. In the lighting system 10, it is possible to increase output of light introduced into the light guide tubes 15 to cause the light guide tubes 15 to shine brighter, and, further, it is possible to thin the light guide tubes 15 to aim for downsizing of the system, reduction in material costs and the like.

A place to install the light guide tubes constituting the lighting system of the present disclosure is not limited to the road 100 as described above. In an example shown in FIG. 6, light guide tubes 115 are provided along the runway 110. By arranging the light guide tubes 115 shining bright to extend along the runway 110, it becomes easy to check the runway 110 from an airplane 111. Those similar to the light guide tubes 15 can be applied as the light guide tubes 115. In the example shown in FIG. 6, three light guide tubes 115 are provided side by side in a width direction of the runway 110. One light guide tube 115 and two light guide tubes 115 are arranged on a central part of the runway 110 in the width direction and both end portions of the runway 110 in the width direction, respectively.

It is preferable that the light guide tubes 115 be accommodated in grooves formed in a road surface of the runway 110. Incoherent light radiated from wavelength converters may be introduced from one end face of the light guide tubes 115 or from both end faces. Light source devices, each of which includes a solid light source and a wavelength converter, are buried in the runway 110 so as not to obstruct, for example, the airplane 111 and other airport vehicles.

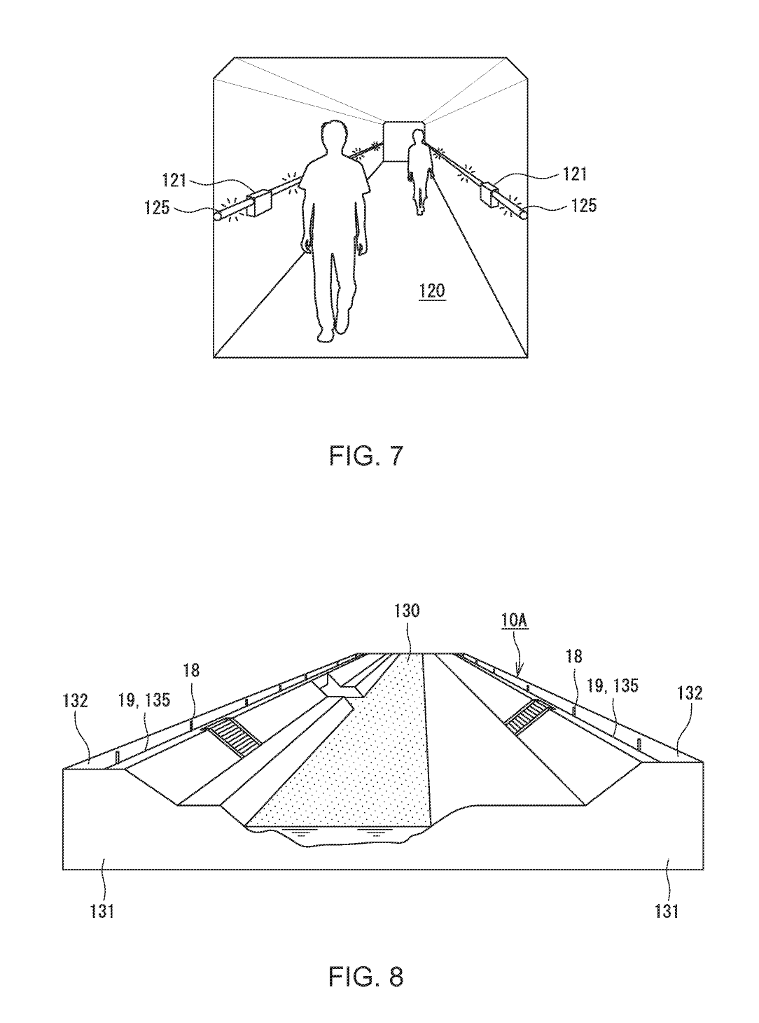

Further, as exemplified in FIG. 7, light guide tubes 125 may be provided along a path 120. The light guide tubes 125 are fixed to wall surfaces on both sides of the path 120. Light source devices 121, each of which includes a solid light source and a wavelength converter, are attached to the wall surfaces of the path 120. For example, two light guide tubes 125 are connected to one light source device 121, and incoherent light is introduced from both end faces of each light guide tube 125.

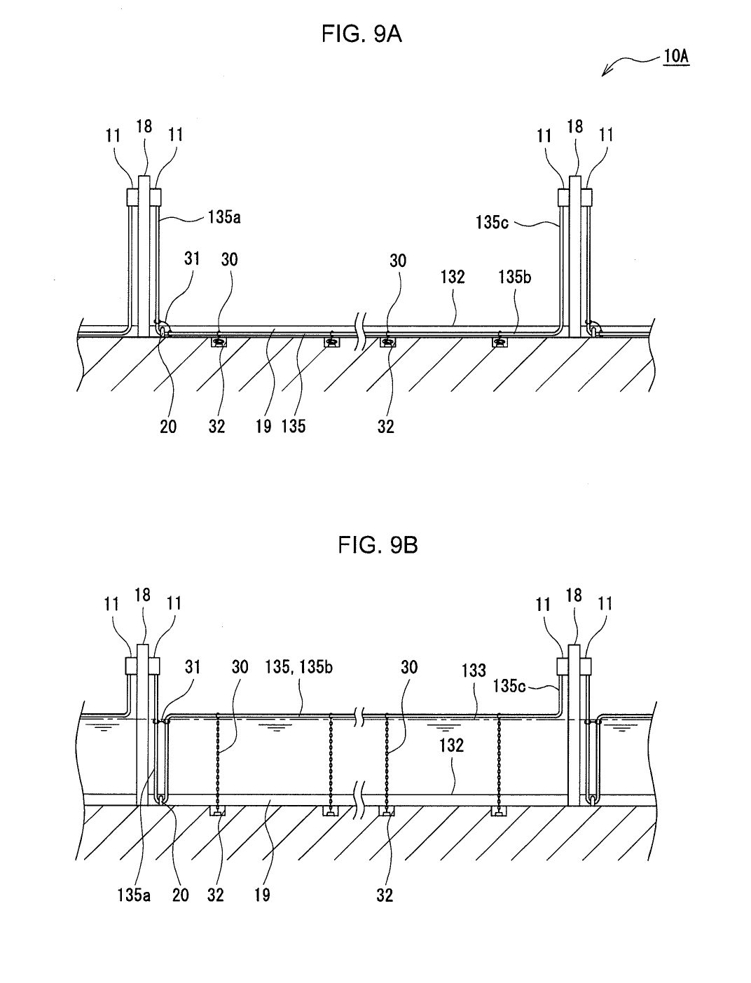

In an example shown in FIG. 8, light guide tubes 135 are provided along the levee road 132 provided on a levee 131 of a river 130. A lighting system 10A applied to the levee road 132 may be configured so that the light guide tubes 135 float up due to submergence of a road surface (see FIGS. 9A and 9B to be described later). When it becomes dark around and when the light guide tubes 135 have floated up, the light guide tubes 135 may be lit up. In this case, the lighting system 10A includes illuminance sensors and sensors for detecting floating of the light guide tubes 135. Further, the light guide tubes 135 have floatability of floating on water.

The lighting system 10A is provided with the light source devices 11 (see FIGS. 9A and 9B), the support columns 18 and the grooves 19 similarly to the lighting system 10. On the road surface of the levee road 132, the plurality of support columns 18 are provided standing at almost equal intervals along a boundary between the river 130 (an inner side of the levee 131) and the levee road 132. The light guide tubes 135 are provided extending along the levee road 132 in a manner of connecting the support columns 18. The light guide tubes 135 are accommodated in the grooves 19 formed in the road surface of the levee road 132.

As shown in FIG. 9A, the lighting system 10A is provided with couplers 30 that connect the light guide tubes 135 to the road surface while securing the floatability of the light guide tubes 135. Recess portions 32 for accommodating the couplers 30 may be formed in the grooves 19. In this case, one end portion of the coupler 30 is fixed to the recess portion 32. Further, an engaging member 31 that couples one end portion 135a and an intermediate portion 135b of the light guide tube 135 that are located on both sides of the fixing member 20 may be provided. The engaging member 31 has, for example, floatability of floating on water, and sinks and floats together with the intermediate portion 135b when the levee road 132 is submerged.

In the lighting system 10A, both end portions of the light guide tube 135 in the length direction (the one end portion 135a and the other end portion 135c) extend in the vertical direction along the support column 18, and the intermediate portion 135b, a remaining part, is extendedly arranged in a state of being accommodated in the groove 19. That is, a length of the light guide tube 135 is longer than an interval between the support columns 18 by the length of the one end portion 135a and the other end portion 135c extending in the vertical direction along the support column 18.

As shown in FIG. 9B, when the river 130 rises, and the levee road 132 is submerged, the light guide tube 135 accommodated in the groove 19 floats up to a water surface 133 and shines bright. Since being connected to the road surface by the coupler 30, the light guide tube 135 floating on the water surface 133 is not carried away but stays on the boundary between the river 130 and the levee road 132. That is, the light guide tube 135 shining bright in the state of floating on the water surface 133 is arranged along the boundary between the river 130 and the levee road 132. Thereby, the boundary between the river 130 and the levee road 132 is made clear, and it is possible to prevent pedestrians and drivers of vehicles and the like from falling into the rising river 130. When water subsides from the road surface, an amount of floating of the light guide tube 135 gradually decreases, and the light guide tube 135 returns into the groove 19 in the end.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A lighting system comprising:
a light source;
a wavelength converter configured to convert a wavelength of light emitted from the light source; and
a light guide tube configured to propagate and transmit incoherent light emitted from the wavelength converter; wherein
the light guide tube extends along a path.

2. The lighting system according to claim 1, wherein the light guide tube includes a light diffusing material and is configured so that optical diffusibility is higher at a part further from an end face onto which the incoherent light is incident than a part closer to the end face.

3. The lighting system according to claim 2, wherein a content of the light diffusing material in the light guide tube gradually increases as a distance from the end face increases.

4. The lighting system according to claim 1, wherein the light guide tube includes a core and a cladding material and is configured to include an uneven shape at least on an outer circumferential face of the cladding material so that optical diffusibility is higher at a part further from an end face onto which the incoherent light is incident than a part closer to the end face.

5. The lighting system according to claim 4, wherein the uneven shape includes unevenness on the outer circumferential face of the cladding material along a length direction of the light guide tube.

6. The lighting system according to claim 4, wherein the uneven shape includes a recess portion, a depth of the recess portion increasing as a distance from the end face increases.

7. The lighting system according to claim 6, wherein a ratio of a length of the recess portion of the uneven shape along a light traveling direction to a width of the recess portion in a direction perpendicular to the light traveling direction increases as a distance from the end face increases.

8. The lighting system according to claim 1, wherein the incoherent light introduced into the light guide tube is configured to propagate in a direction opposite to a traveling direction of the path.

9. The lighting system according to claim 1, wherein the wavelength converter converts the wavelength of the light of the light source to at least one of a visible wavelength and an infrared wavelength.

10. The lighting system according to claim 1, wherein the light guide tube is on a surface of the path.

11. The lighting system according to claim 10, wherein the path is a road or a runway.

12. The lighting system according to claim 11, wherein the light guide tube is in a groove in the surface of the path.

13. The lighting system according to claim 11, wherein the light guide tube is configured to float.

14. The lighting system according to claim 13, further comprising;
a coupler connecting the light guide tube to the surface of the path to prevent the light guide tube from floating.

15. The lighting system according to claim 1, wherein
the light guide tube includes a core and a cladding material; and
a surface of the cladding material is coated with fluororesin.

16. The lighting system according to claim 1, wherein the light source is a semiconductor laser outputting near-ultraviolet light or blue light.

17. The lighting system according to claim 1, wherein the light source is a solid light source.
